(19) United States
(12) Patent Application Publication
(10) Pub. No.: US 2024/0184747 A1
(43) Pub. Date: Jun. 6, 2024

(54) METHOD AND SYSTEM FOR BLOCKCHAIN-BASED DATA MANAGEMENT

(71) Applicant: International Trust Machines Corporation, New Taipei (TW)

(72) Inventor: GWAN-HWAN HWANG, New Taipei (TW)

(21) Appl. No.: 18/524,376

(22) Filed: Nov. 30, 2023

Related U.S. Application Data
(60) Provisional application No. 63/429,373, filed on Dec. 1, 2022.

(51) Int. Cl. G06F 16/13; G06F 16/23; H04L 9/00; H04L 9/30

(52) U.S. Cl. CPC G06F 16/137; G06F 16/2365; H04L 9/30; H04L 9/50

(57) ABSTRACT

A method and system for blockchain-based data management is provided. The method includes receiving first data of a first category; recording the first data on a first tree based on a first index, the first index including a first key and a first serial number, the first key associated with the first category and the first serial number indicating a sequential count of the first data being of the first category and recorded on the first tree; obtaining a first slice partitioned from the first tree and associated with the first index; generating a first root hash of the first tree and storing the first root hash by a blockchain; and storing a first proof in an off-chain database, where the first proof includes the first slice partitioned from the first tree.

### CROSS-REFERENCE TO RELATED APPLICATION

The present application claims the benefit of and priority to U.S. Provisional Patent Application Ser. No. 63/429,373, filed on Dec. 1, 2022, entitled “DATA MANAGEMENT SYSTEM WITH TRACEABLE HISTORY BASED ON BLOCKCHAIN TECHNOLOGY,” the contents of which are hereby incorporated herein fully by reference for all purposes.

### FIELD

The present disclosure generally relates to data management and, more particularly, to a method and system for managing data using blockchain technology with high efficiency, to ensure data immutability and transparency.

### BACKGROUND

Non-Fungible Tokens (NFTs) have catalyzed a paradigm shift in the digital asset landscape by providing unique identification and authentication of digital items via blockchain technology. Traditionally, NFTs have been associated with static digital assets, such as artwork, collectibles, or media files. The uniqueness and ownership of these assets are securely encoded on the blockchain, ensuring their immutability and verifiability.

Over time, there has been a growing demand for NFTs capable of supporting dynamic data—data that can change or evolve over time. This advancement would significantly broaden the scope of NFTs, enabling them to represent assets with attributes or metadata that change over time, such as evolving digital art, in-game items, or assets reflecting real-world changes.

Existing approaches to dynamic NFTs primarily rely on smart contract standards, such as ERC1155, which allows for the modification of a token's metadata through URLs. However, this method faces a significant limitation: it depends on centralized databases for managing these changes. Such dependence on centralized databases contradicts the core principle of decentralization inherent in blockchain technology, leading to potential trust issues. Centralized systems managing dynamic NFT content are prone to unauthorized alterations or censorship, and may even be completely controlled by a single entity, thereby undermining the transparent and immutable nature of blockchain technologies.

Consequently, there is an urgent need for a technology that not only supports the dynamic change of NFT data but also maintains data integrity and trustworthiness within a decentralized framework. This new technology should manage dynamic data effectively without reliance on any centralized managements, ensuring its integrity and credibility, and thus actualizing the true concept of “zero trust” within blockchain data management.

### SUMMARY

In view of the above, the present disclosure provides a method and system for blockchain-based data management, which are capable of managing dynamic data while ensuring data immutability and integrity efficiently within a decentralized framework.

In a first aspect of the present disclosure, a method for blockchain-based data management is provided. The method includes: receiving first data of a first category; recording the first data on a first tree based on a first index, the first index including a first key and a first serial number, the first key associated with the first category and the first serial number indicating a sequential count of the first data being of the first category and recorded on the first tree; obtaining a first slice partitioned from the first tree and associated with the first index; generating a first root hash of the first tree and storing the first root hash by a blockchain; and storing a first proof in an off-chain database, where the first proof includes the first slice partitioned from the first tree.

In some implementations of the first aspect, the method further includes: receiving second data of the first category after receiving the first data; recording the second data on the first tree based on a second index, the second index including the first key and a second serial number determined based on the first serial number and a predetermined rule; and obtaining a second slice partitioned from the first tree and associated with the second index, where the first proof further includes the second slice of the first tree.

In some implementations of the first aspect, the method further includes: obtaining a supplementary slice partitioned from the first tree and associated with a supplementary index, the supplementary index including the first key and a supplementary serial number indicating a total count of data received that are of the first category and recorded on the first tree, where the first proof includes the supplementary slice of the first tree, and a leaf node of the first tree corresponding to the supplementary index records no content.

In some implementations of the first aspect, the method further includes: after storing the first root hash by the blockchain, obtaining a second slice partitioned from a second tree and associated with a second index, the second index including the first key and a second serial number determined based on a predetermined rule; generating a second root hash of the second tree and storing the second root hash by the blockchain; and updating the first proof corresponding to the first category in the off-chain database to include the second slice.

In some implementations of the first aspect, the method further includes: receiving second data of the first category; recording the second data on the second tree based on the second index.

In some implementations of the first aspect, a leaf node of the second tree corresponding to the second index records no content.

In some implementations of the first aspect, the method further includes: obtaining the first root hash of the first slice and the second root hash of the second slice from the off-chain database; calculating a first chain hash based on the first root hash and the second root hash obtained from the off-chain database; obtaining the second root hash and a second chain hash from the blockchain; and verifying the first slice and the second slice in the off-chain database by comparing the first chain hash with the second chain hash.

In some implementations of the first aspect, the second chain hash is calculated by the blockchain based on the first root hash.

In some implementations of the first aspect, the first data is calculated according to an original digital file and the method further includes: receiving and storing the original digital file in the off-chain database; and associating the original digital file with the first proof in the off-chain database.

In some implementations of the first aspect, the method further includes: receiving second data of a second category different from the first category; recording the second data on the first tree based on a second index, the second index including a second key and a second serial number, the second key associated with the second category and different from the first key, and the second serial number indicating a sequential count of the second data being of the second category and recorded on the first tree; and obtaining a second slice partitioned from the first tree and associated with the second index, where the first proof includes the second slice partitioned from the first tree.

In a second aspect of the present disclosure, a system is provided. The system cooperates with a blockchain and an off-chain database and configured to: receive first data of a first category; record the first data on a first tree based on a first index, the first index including a first key and a first serial number, the first key associated with the first category and the first serial number indicating a sequential count of the first data being of the first category and recorded on the first tree; obtain a first slice partitioned from the first tree and associated with the first index; generate a first root hash of the first tree and store the first root hash by the blockchain; and store a first proof in the off-chain database, where the first proof includes the first slice partitioned from the first tree.

In some implementations of the second aspect, the system is further configured to: receive second data of the first category after receiving the first data; record the second data on the first tree based on a second index, the second index including the first key and a second serial number determined based on the first serial number and a predetermined rule; and obtain a second slice partitioned from the first tree and associated with the second index, where the first proof further includes the second slice of the first tree.

In some implementations of the second aspect, the system is further configured to: obtain a supplementary slice partitioned from the first tree and associated with a supplementary index, the supplementary index including the first key and a supplementary serial number indicating a total count of data received that are of the first category and recorded on the first tree, where the first proof includes the supplementary slice of the first tree, and a leaf node of the first tree corresponding to the supplementary index records no content.

In some implementations of the second aspect, the system is further configured to: after storing the first root hash by the blockchain, obtain a second slice partitioned from a second tree and associated with a second index, the second index including the first key and a second serial number determined based on a predetermined rule; generate a second root hash of the second tree and storing the second root hash by the blockchain; and update the first proof corresponding to the first category in the off-chain database to include the second slice.

In some implementations of the second aspect, the system is further configured to: receive second data of the first category; and record the second data on the second tree based on the second index.

In some implementations of the second aspect, a leaf node of the second tree corresponding to the second index records no content.

In some implementations of the second aspect, the system is further configured to: obtain the first root hash of the first slice and the second root hash of the second slice from the off-chain database; calculate a first chain hash based on the first root hash and the second root hash obtained from the off-chain database; obtain the second root hash and a second chain hash from the blockchain; and verify the first slice and the second slice in the off-chain database by comparing the first chain hash with the second chain hash.

In some implementations of the second aspect, the second chain hash is calculated by the blockchain based on the first root hash.

In some implementations of the second aspect, the first data is calculated according to an original digital file and the system is further configured to: receive and storing the original digital file in the off-chain database; and associating the original digital file with the first proof in the off-chain database.

In some implementations of the second aspect, the system is further configured to: receive second data of a second category different from the first category; record the second data on the first tree based on a second index, the second index including a second key and a second serial number, the second key associated with the second category and different from the first key, and the second serial number indicating a sequential count of the second data being of the second category and recorded on the first tree; and obtain a second slice partitioned from the first tree and associated with the second index, where the first proof includes the second slice partitioned from the first tree.

### BRIEF DESCRIPTION OF THE DRAWINGS

FIG. 1 is a schematic diagram illustrating a verification system, in accordance with an example implementation of the present disclosure.

FIG. 2 is a schematic diagram illustrating a binary tree, in accordance with an example implementation of the present disclosure.

FIG. 3 is a schematic diagram illustrating a chain data string, in accordance with an example implementation of the present disclosure.

FIG. 3a is a schematic diagram illustrating a chain data string, in accordance with an example implementation of the present disclosure.

FIG. 4 is a schematic block diagram illustrating a verification system, in accordance with an example implementation of the present disclosure.

FIG. 5 is a schematic block diagram illustrating a verification system, in accordance with an example implementation of the present disclosure.

FIG. 6 is a schematic diagram illustrating a chain data string, in accordance with an example implementation of the present disclosure.

FIG. 7 is a schematic diagram illustrating a slice of a binary tree, in accordance with an example implementation of the present disclosure.

FIG. 8 is a flowchart illustrating a method for blockchain-based data management, in accordance with an example implementation of the present disclosure.

FIG. 9 is a schematic diagram illustrating a proof, in accordance with an example implementation of the present disclosure.

FIG. 10 is a schematic diagram illustrating a method for blockchain-based data management, in accordance with an example implementation of the present disclosure.

### DETAILED DESCRIPTION

The following will refer to the relevant drawings to describe implementations of a method and a system for blockchain-based data management in the present disclosure, in which the same components will be identified by the same reference symbols.

The following description includes specific information regarding the exemplary implementations of the present disclosure. The accompanying detailed description and drawings of the present disclosure are intended to illustrate the exemplary implementations only. However, the present disclosure is not limited to these exemplary implementations. Those skilled in the art will appreciate that various modifications and alternative implementations of the present disclosure are possible. In addition, the drawings and examples in the present disclosure are generally not drawn to scale and do not correspond to actual relative sizes.

The term “couple” is defined as a connection, whether direct or indirect, through an intermediate component, and is not necessarily limited to a physical connection. When the terms “comprising” or “including” are used, they mean “including but not limited to,” and explicitly indicate an open relationship between the combination, group, series, and the like.

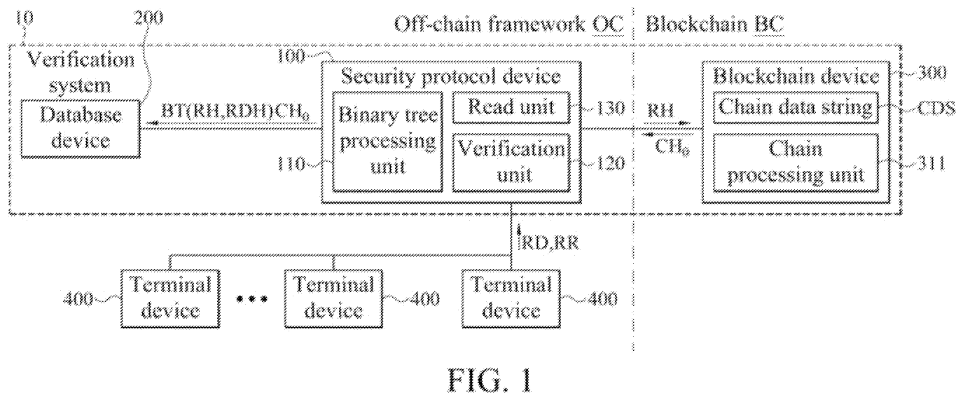

FIG. 1 is a schematic diagram illustrating a verification system, in accordance with an example implementation of the present disclosure.

Referring to FIG. 1, the verification system 10 may cooperate with a blockchain BC. The blockchain BC may include a public blockchain, a private blockchain, or a combination thereof.

In some implementations, the verification system 10 may be configured to communicate with multiple terminal devices 400 in an off-chain manner, e.g., via an off-chain framework OC including, for example, one or more off-chain devices and/or one or more off-chain channels not involved in the blockchain BC. The verification system 10 may cooperate with the off-chain framework OC and the blockchain BC. Each terminal device 400 may generate at least one record data RD. The off-chain framework OC refers to a path that is independent of the blockchain BC, that is, a path that is not involved in the blockchain BC. The off-chain framework OC communication refers to a communication relationship on a path independent of the blockchain BC. For example, communication between two devices via an off-chain framework OC means that the two devices may be connected and transmit signals to each other through networks without involving the blockchain BC. The terminal device 400 may be, for example, a desktop computer, a notebook computer, or various sensors. The record data RD may be, for example, a file, a document, works, or transaction information generated by a desktop computer or a notebook computer, or numerical information sensed by a sensor, but is not limited thereto.

The verification system 10 may include a security protocol device 100, a database device 200, and a blockchain device 300. The security protocol device 100 may communicate with the database device 200 via the off-chain framework OC not involved in the blockchain BC, and the security protocol device 100 may communicate with the blockchain device 300 located on the blockchain BC. The database device 200 may be, for example, a data storage server independent of the blockchain BC, and the blockchain device 300 may be, for example, a collection of multiple computers connected to the blockchain BC, but is not limited thereto.

In some implementations, the security protocol device 100 may be a server that combines communication capabilities of the blockchain BC and the off-chain framework OC. For example, the security protocol device 100 may be an intermediary between the off-chain framework OC and the blockchain BC, and may serve as a bridge between the terminal device 400 and the database device 200 as well as the blockchain device 300, which will be detailed later.

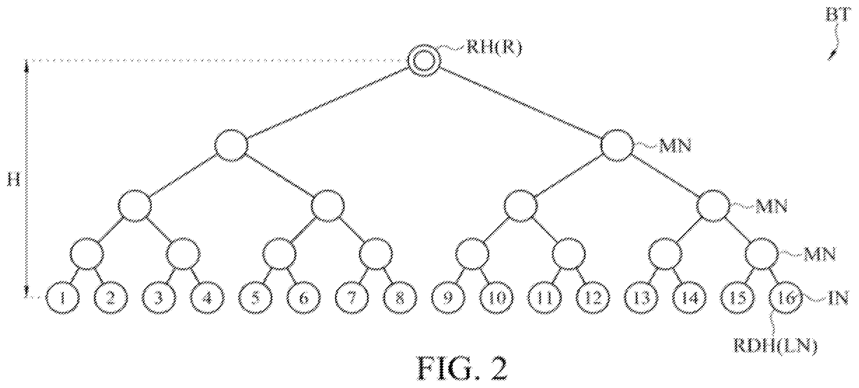

FIG. 2 is a schematic diagram illustrating a binary tree, in accordance with an example implementation of the present disclosure.

Referring to FIGS. 1 and 2, after each terminal device 400 generates the record data RD, each terminal device 400 may transmit the record data RD to the security protocol device 100 via the off-chain framework OC. After the security protocol device 100 receives the record data RD of each terminal device 400 via the off-chain framework OC, the security protocol device 100 may integrate the record data RD into at least one binary tree BT according to a hash function.

As shown in FIG. 2, the binary tree BT may include a root R, multiple middle nodes MN, and multiple leaf nodes LN. In the tree data structure of the binary tree BT, the root R may be located at the top layer, the leaf nodes LN may be located at the bottom layer, and the middle nodes MN may be distributed at one or more layers between the top layer and the bottom layer. Every two adjacent leaf nodes LN may integrate at an upper layer and become a middle node MN. Every two adjacent middle nodes MN at each layer may integrate at an upper layer and become a middle node MN. Two middle nodes MN at the topmost layer may integrate and become the root R. Each leaf node LN may store the respective one of the hash values RDH of the record data RD. A hash value of each middle node MN and a root hash RH in the root R may be related to the hash values RDH of the record data RD.

For example, the security protocol device 100 may use the SHA-256 hash function to hash the record data RD to generate corresponding hash values RDH, and the security protocol device 100 respectively may store the hash values RDH of the record data RD to the respective leaf nodes LN. Moreover, the two hash values stored in each set of two adjacent leaf nodes LN may be connected and then hashed and stored in the middle node MN at the upper layer, the two hash values stored in each set of two adjacent middle nodes MN at each layer may be connected and then hashed and stored in the middle node MN at the upper layer, and so on.

In some implementations, the two hash values may be connected and then hashed in a manner that the two hash values are first connected into a string of code and then the string of code may be hashed, but not limited thereto. For example, if the first hash value is “xxx”, and the second hash value is “ooo”, the two hash values may be first connected as a string of code of “xxxooo”, and the string code “xxxooo” may be hashed again to generate a hash value. Finally, the two hash values stored in the two middle nodes MN at the topmost layer may be connected and hashed to generate a root hash RH. In other words, the binary tree BT may include the hash values RDH of the record data RD stored in the leaf nodes LN and the root hash RH stored in the root R. Moreover, the record data RD may not be tampered with. This is because as long as any record datum RD in the binary tree BT has been tampered with, the hash value RDH of the record datum RD will change. As long as the hash value RDH of the record datum RD of any leaf node LN changes, the root hash RH of the binary tree BT also changes accordingly. By judging whether the root hash RH changes, the correctness of the record data RD corresponding to the binary tree BT may be verified.

In some implementations, a single leaf node LN may also store the hash values RDH of two or more record data RD. In this case, the hash values RDH stored in the leaf node LN may be values obtained by connecting and hashing the hash values RDH of two or more record data RD.

As shown in FIGS. 1 and 2, the security protocol device 100 may include a binary tree processing unit 110 and a verification unit 120. The binary tree processing unit 110 and the verification unit 120 may be, for example but not limited to, functional modules formed by software/hardware to perform specific functions respectively. The binary tree processing unit 110 and the verification unit 120 may be independent modules or an integrated module.

In some implementations, the binary tree processing unit 110 of the security protocol device 100 may hash and integrate the received record data RD to generate a binary tree BT. The security protocol device 100 may transmit the root hashes RH of the binary trees BT to the blockchain device 300, that is, these root hashes RH may be stored on the blockchain BC. In addition, the security protocol device 100 may store the binary trees BT in the database device 200. That is, the complete binary tree BT may be stored via the off-chain framework OC, instead of being stored on the blockchain BC. In some implementations, the complete binary tree BT may also be stored in the database device 200 and transmitted to the blockchain device 300.

In some implementations, the verification unit 120 of the security protocol device 100 may verify the correctness of the binary tree BT stored in the database device 200. When the security protocol device 100 receives a verification request, and the verification request is to verify the correctness of a certain record datum RD, the verification unit 120 may compare the root hash RH of the binary tree BT corresponding to the record datum RD on the blockchain device 300 with the root hash RH of the binary tree BT corresponding to the record datum RD stored in the database device 200, so as to verify the correctness of the binary tree BT stored in the database device 200. If the root hash RH on the blockchain device 300 is consistent with the root hash RH of the binary tree BT stored in the database device 200, based on the characteristics of the blockchain BC, it may indicate that the binary tree BT of the record datum RD stored in the database device 200 is correct.

Since the complete binary tree BT is located in the database device 200 via the off-chain framework OC, the access and operation of the hash values RDH of the record data RD may be mainly performed via the off-chain framework OC, and the network transmission requirements, operation amount, operation time, and operation costs for this task which is traditionally performed on the blockchain BC may be saved. Moreover, the root hash RH of the binary tree BT in the database device 200 may be verified by comparing with the corresponding root hashes RH on the blockchain device 300, and the correctness of the data in the database device 200 via the off-chain framework OC may be ensured.

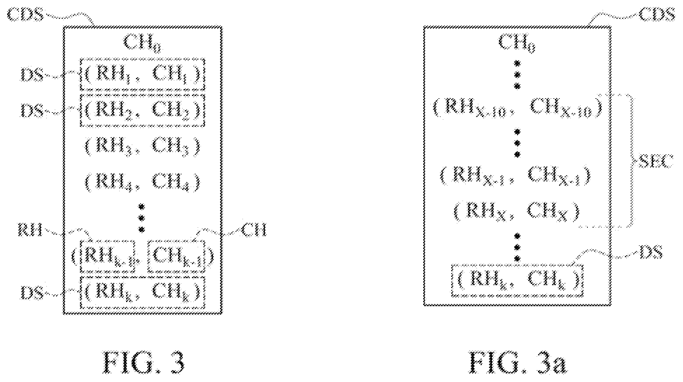

FIG. 3 is a schematic diagram illustrating a chain data string, in accordance with an example implementation of the present disclosure.

Referring to FIGS. 1 and 3, the blockchain device 300 may include at least one chain data string CDS, and the chain data string CDS may include multiple data sets DS chained in a series manner. The series manner means from the first datum, the second datum, and the third datum sequentially to the last but one datum and the last datum, and each datum is related to the previous datum. For example, the second datum may be related to the first datum, the third datum may be related to the second datum, the last datum may be related to the last but one datum, and so on.

In some implementations, each data set DS may include a respective root hash RH and a corresponding chain hash CH. The chain hash CH of each data set DS may be related to the root hash RH and the chain hash CH of the previous data set DS. The chain hash CH of the first data set DS may be related to an initial chain hash CH₀.

As shown in FIG. 1, the blockchain device 300 may include a chain processing unit 311, and the chain processing unit 311 may be configured to generate the chain data string CDS. As shown in FIGS. 1 and 3, after the blockchain device 300 receives root hashes RH of multiple binary trees BT, the chain processing unit 311 may sequentially generate data sets DS according to the generating or receiving time of the root hashes RH of the received binary trees BT. The chain hash CH of each data set DS may be generated by hashing the previous data set DS. The chain hash CH of the first data set DS may be generated by hashing the initial chain hash CH₀.

In some implementations, the chain processing unit 311 may first generate the initial chain hash CH₀. The initial chain hash CH₀ may be any value or a combination of any letter or number. Moreover, the chain processing unit 311 may generate multiple data sets DS chained in a series manner in the chain data string CDS according to the following two formulas:

CHᵢ=hash(RHᵢ₋₁|CHᵢ₋₁); and

CHᵢ=hash(CH₀),
where RHᵢ₋₁ is root hash RH, CHᵢ₋₁ is chain hash CH, and i is an integer from 2 to k.

As shown in FIG. 3, the first data set DS may have the root hash RH of RH₁ and the chain hash CH of CH₁, and CH₁ may be a hash value generated by hashing CH₀. The latter (arranged after the first data set DS) second data set DS may have the root hash RH of RH₂ and the chain hash CH of CH₂, and the CH₂ may be a hash value generated by hashing the connected RH₁ and CH₁. As described above, hashing of the connected RH₁ and CH₁ may be implemented by connecting RH₁ and CH₁ and then performing the hashing, but is not limited thereto. The latter (arranged after the second data set DS) third data set DS may have the root hash RH of RH₃ and the chain hash CH of CH₃, and the CH₃ may be a hash value generated by hashing the connected RH₂ and CH₂. The last data set DS may have the root hash RH of RHₖ and the chain hash CH of CHₖ, and the CHₖ may be a hash value generated by hashing the connected RHₖ₋₁ and CHₖ₋₁. The root hashes RH and the chain hashes CH of the rest data sets DS may be deduced by analogy. Moreover, these data sets DS chained in the series manner may form the chain data string CDS. In some implementations, the security protocol device 100 may store the initial chain hash CH₀ to the database device 200, but is not limited thereto.

As shown in FIGS. 1 and 3, the security protocol device 100 may further include a read unit 130. The read unit 130 may be configured to read corresponding data from the blockchain device 300 and the database device 200. The terminal device 400 may transmit a read request RR to the security protocol device 100 to read the root hashes RH of one or more binary trees BT. When the security protocol device 100 receives the read request RR, the read request RR is to read multiple root hashes RH, and the plurality of root hashes RH belongs to multiple data sets DS of the chain data string CDS, the read unit 130 may read the root hash RH of the latter data set DS of the chain data string CDS from the blockchain device 300, and read one or more of the root hashes RH of the former data sets DS of the chain data string CDS from the database device 200, and the security protocol device 100 may verify the correctness of the former one or more root hashes RH of the database device 200 by using the chain hash CH of the latter data set DS of the blockchain device 300.

For example, when the security protocol device 100 receives the read request RR, and the read request RR is to read k root hashes RH from RH₁ to RHₖ of the chain data string CDS as in FIG. 3, the read unit 130 may reads the root hash RH and the chain hash CH (e.g., RHₖ and CHₖ) of the last data set DS of the data sets DS of the chain data string CDS from the blockchain device 300. Moreover, the read unit 130 may reads the root hashes RH (e.g., from RH₁ to RHₖ₋₁) of the former data sets DS from the database device 200; and the verification unit 120 may verify the correctness of RH₁ to RHₖ₋₁ of the former data sets DS of the database device 200 by using RHₖ of the last data set DS. The verification unit 120 may use the aforementioned two formulas and the initial chain hash CH₀ and RH₁ to RHₖ₋₁ stored in the database device 200 to perform hashing and chaining operation to calculate CHₖ, and compares the calculated CHₖ with CHₖ on the blockchain device 300. If the calculated CHₖ is consistent with CHₖ on the blockchain device 300, it may indicate that RH₁ to RHₖ₋₁ stored in the database device 200 are consistent with RH₁ to RHₖ₋₁ on the blockchain device 300. Because it is based on hashing operation, as long as any root hash RH in RH₁ to RHₖ₋₁ stored in the database device 200 is inconsistent with the corresponding root hash RH in RH₁ to RHₖ₋₁ on the blockchain device 300, the calculated CHₖ may be different from CHₖ on the blockchain device 300.

FIG. 3a illustrates a schematic diagram of a chain data string in accordance with an example of the present disclosure.

Referring to FIG. 3a, the chain data string CDS in FIG. 3a is substantially the same as the chain data string CDS in FIG. 3. However, for ease of description, the chain data string CDS in FIG. 3a shows a data section SEC of a continuous data set DS. As shown in FIG. 3a, in some implementations, the security protocol device 100 may further read data sets DS of any data section SEC of the chain data string CDS, and perform verification by using the last data set DS of the data section SEC.

For example, when the security protocol device 100 receives the read request RR, and the read request RR is to read 11 root hashes RH from RHₓ₋₁₀ to RHₓ of the data section SEC of the chain data string CDS as in FIG. 3, where x is less than k and greater than or equal to 10, the read unit 130 may read the root hash RH and the chain hash CH (RHₓ and CHₓ) of the last data set DS of the data sets DS of the data section SEC from the blockchain device 300, and the read unit 130 may read the root hashes RH (e.g., from RHₓ₋₁₀ to RHₓ₋₁) of the former data sets DS of the data section SEC from the database device 200. Moreover, the verification unit 120 may verify the correctness of RHₓ₋₁₀ to RHₓ₋₁ of the former data sets DS of the data section SEC of the database device 200 by using RHₓ of the last data set DS of the data section SEC.

In some implementations, the initial chain hash CH₀ may not be stored in the database device 200. Instead, when the security protocol device 100 receives the read request RR, the read unit 130 may read the initial chain hash CH₀ of the chain data string CDS and the root hash RH of the latter data set DS of the data sets DS from the blockchain device 300, and read one or more of the root hashes RH of the former data sets DS of the chain data string CDS from the database device 200.

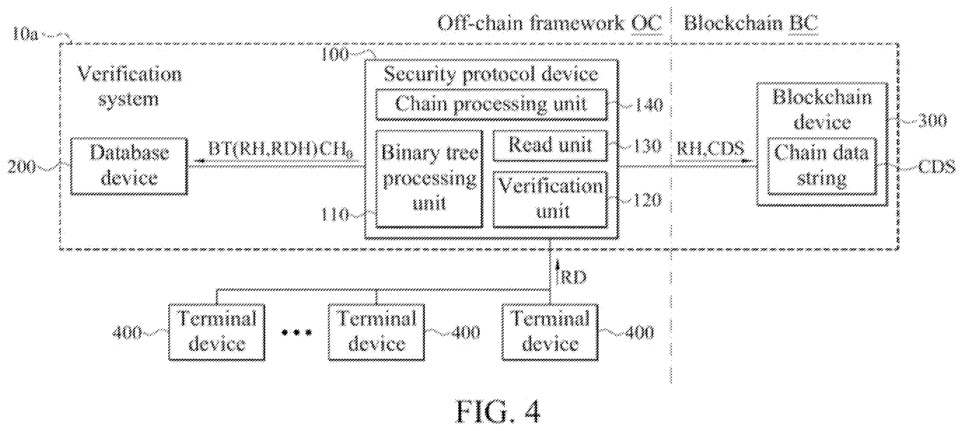

FIG. 4 is a schematic block diagram illustrating a verification system 10a, in accordance with an example implementation of the present disclosure. The same or similar components, connection relationships, and functions of the verification systems 10 and 10a in FIG. 1 and FIG. 4 are not described again. One of the differences between the verification system 10a in FIG. 4 and the verification system 10 in FIG. 1 is that the security protocol device 100 of the verification system 10a in FIG. 4 may further include a chain processing unit 140, and the blockchain device 300 may not be provided with a chain processing unit.

In some implementations, after the binary tree processing unit 110 of the security protocol device 100 generates multiple binary trees BT, the chain processing unit 140 of the security protocol device 100 may generate data sets DS according to multiple root hashes RH of the binary trees BT, and generate a chain data string CDS according to the aforementioned two formulas, and the security protocol device 100 may transmit the chain data string CDS to the blockchain device 300. That is, the data transmitted by the security protocol device 100 to the blockchain BC may be a data structure having the chain data string CDS.

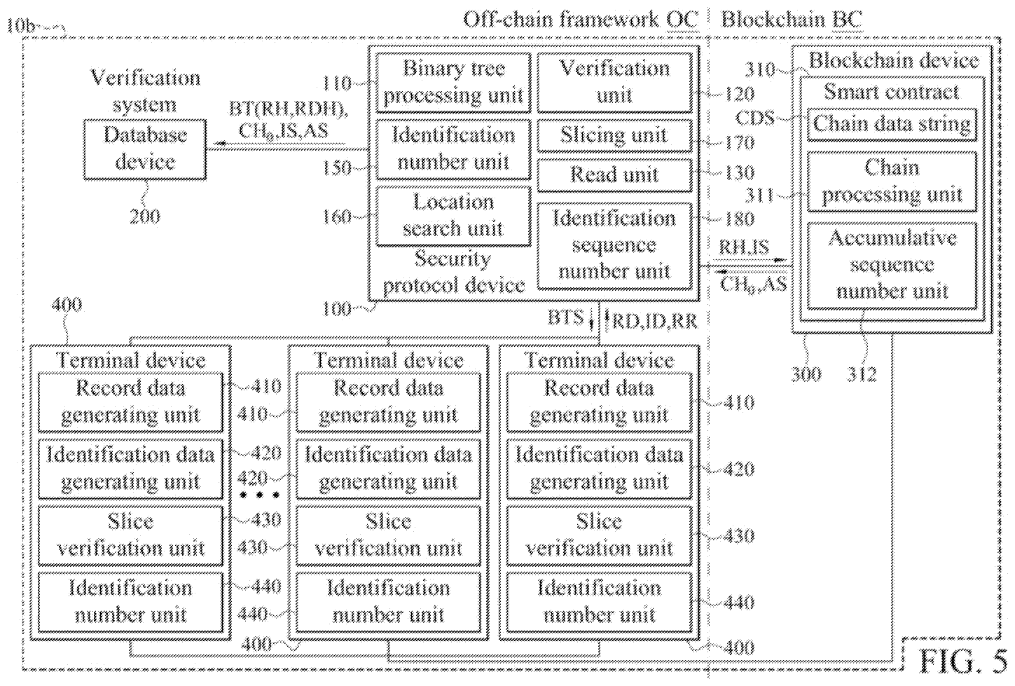

FIG. 5 is a schematic block diagram illustrating a verification system 10b, in accordance with an example implementation of the present disclosure. The same or similar components, connection relationships, and functions of the verification systems 10 and 10b in FIG. 1 and FIG. 5 are not described again. One of the differences between the verification system 10b in FIG. 5 and the verification system 10 in FIG. 1 is that the verification system 10b in FIG. 5 may include a security protocol device 100, a database device 200, a blockchain device 300, and multiple terminal devices 400. The security protocol device 100 may communicate with the blockchain device 300 located at the blockchain BC, and communicate with the database device 200 and the terminal devices 400 via the off-chain framework OC. The terminal devices 400 may further communicate with the blockchain device 300. The security protocol device 100 may include a binary tree processing unit 110, a verification unit 120, a read unit 130, an identification number unit 150, a location search unit 160, a slicing unit 170, and an identification sequence number unit 180. The binary tree processing unit 110, the verification unit 120, the read unit 130, the identification number unit 150, the location search unit 160, the slicing unit 170, and the identification sequence number unit 180 may be, for example but not limited to, functional modules formed by software/hardware to perform specific functions respectively, and the binary tree processing unit 110, the verification unit 120, the read unit 130, the identification number unit 150, the location search unit 160, the slicing unit 170, and the identification sequence number unit 180 may be independent modules or an integrated module.

As shown in FIG. 5, in some implementations, the blockchain device 300 may include at least one smart contract 310, and the root hash RH transmitted by the security protocol device 100 to the blockchain device 300 may be stored in the corresponding smart contract 310. In some implementations, the blockchain device 300 may also include a program architecture or interface that is different from the smart contract, and the root hash RH may be stored in the blockchain device 300 corresponding to the different program architecture or interface.

As shown in FIG. 5, in some implementations, each terminal device 400 may include a record data generating unit 410, an identification data generating unit 420, and a slice verification unit 430. The record data generating unit 410, the identification data generating unit 420, and the slice verification unit 430 may be, for example but not limited to, functional modules formed by software/hardware to perform specific functions respectively. The record data generating unit 410, the identification data generating unit 420, and the slice verification unit 430 may be independent modules or an integrated module. The record data generating unit 410 may be configured to generate the aforementioned record data RD. Moreover, when the record data generating unit 410 of each terminal device 400 may generate the record data RD, the identification data generating unit 420 of each terminal device 400 may also generate multiple identification data ID respectively corresponding to the record data RD, so that each of the record data RD may have a corresponding identification data ID. The terminal device 400 may transmit the record data RD and the corresponding identification data ID to the security protocol device 100 at the same time. In some implementations, the terminal device 400 may integrate the record data RD and the corresponding identification data ID into integrated data and transmit the integrated data to the security protocol device 100. In some implementations, the identification data ID may be a plain code.

As shown in FIG. 5, in some implementations, the security protocol device 100 may receive the record data RD and the corresponding identification data ID, and the security protocol device 100 may store the hash values RDH of the record data RD to the corresponding leaf nodes LN according to the identification data ID. For example, after the security protocol device 100 receives the identification data ID, the identification number unit 150 of the security protocol device 100 may generates multiple identification numbers IN respectively corresponding to the leaf nodes LN according to the identification data ID, and the security protocol device 100 may store the hash values RDH of the record data RD to the corresponding leaf nodes LN according to the identification numbers IN. In this case, each identification number IN may be unique in any binary tree BT, and each of the identification numbers IN may correspond to the respective one of the leaf nodes LN in the binary tree BT. Therefore, the hash value RDH of each of the record data RD may be located at the respective one of the leaf nodes LN by using the corresponding identification number IN, which will be described in detail later.

In some implementations, the identification number unit 150 of the security protocol device 100 may extract multiple predetermined bits from the hash value of the respective one of the identification data ID to generate the respective one of the identification numbers IN. Moreover, the number of the predetermined bits may be related to a height value H of the corresponding binary tree BT. When the binary tree BT has a height value H, the binary tree BT may have 2^{(H-1)} leaf nodes LN. In order to enable the leaf nodes LN of the binary tree BT to have corresponding and exclusive unique identification numbers IN, the predetermined bits may be at least H−1 bits extracted from the respective one of the hash values of the identification data ID. In this way, the arrangement of the H−1 bits may satisfy the number of the leaf nodes LN, so that the identification numbers IN corresponding to the leaf nodes LN are unique and not repeated. The H−1 bits may be, for example but not limited to, the first H−1 bits in the respective one of the hash values of the identification data ID. The H−1 bits may be, for example but not limited to, the last H−1 bits extracted from the respective one of the hash values of the identification data ID or H−1 bits in any location.

For example, the height value H of the binary tree BT of FIG. 2 is 5, and the binary tree BT has 2⁽⁵⁻¹⁾ leaf nodes LN, that is, the binary tree BT has 16 leaf nodes LN. Assuming that identification data ID corresponding to a certain record datum RD is “E1534391”, the identification number unit 150 may hash the identification data ID by using the SHA-256 hash function to generate a hash value “dbb9ed8b677468b4834d2f634a77ea1e6663431bf1ee7523041467ff8023fa64”. Next, the identification number unit 150 may extract the first four bits “1101” of the binary bit sequence converted by the hash value, and convert “1101” to the decimal value “13”, thereby generating the identification number IN as “13”. The identification number unit 150 may sequentially set all the 16 leaf nodes LN of the binary tree BT to the leaf nodes LN numbered 1 to 16, and the hash value RDH of the record datum RD with the identification number IN of 13 may be stored in the leaf node LN numbered 13.

In some implementations, different identification data ID may generate the same identification number IN, or different recording data RD may have the same identification data ID and generate the same identification number IN. In this case, the hash values RDH of the plurality of record data RD may correspond to the same identification number IN and be stored in the same leaf node LN.

In some implementations, each leaf node LN of the binary tree BT may store the hash values RDH of two or more record data RD, and the hash values RDH of the two or more record data RD corresponding to a certain leaf node LN may be connected and then hashed to generate a hash value. The hash value corresponding to the two or more record data RD may be stored in the leaf node LN.

As shown in FIG. 5, in some implementations, the location search unit 160 of the security protocol device 100 may locate the hash values RDH of the record data RD by using the identification numbers IN. When a user needs to search or verify a hash value RDH corresponding to a certain record datum RD in a certain binary tree BT in the database device 200, the user may perform the above task by using the security protocol device 100. In this case, the location search unit 160 of the security protocol device 100 may locate the hash value RDH of the record datum RD (e.g., the stored leaf node LN) by an identification number IN, and extract the hash value RDH of the record datum RD directly from the leaf node LN of the binary tree BT corresponding to the identification number IN, so as to quickly locate and search for data. Moreover, to verify that a certain record datum RD does not exist, it may also be completed by using the identification number IN. The security protocol device 100 does not need to obtain all the hash values in the complete binary tree BT. The location search unit 160 of the security protocol device 100 may locate the hash value RDH of the record datum RD, e.g., the corresponding leaf node LN, by using an identification number IN corresponding to the record datum RD, and may directly confirm whether the hash value RDH of the record datum RD exists in the leaf node LN. If the leaf node LN does not have the hash value RDH of the record datum RD, it may be verified that the record datum RD does not exist. In this way, the network transmission requirements, operation amount, operation time, and operation costs of the entire verification task may be greatly reduced.

As shown in FIG. 5, in some implementations, the terminal device 400 may further include an identification number unit 440. The identification number unit 440 of the terminal device 400 may have the same function as the identification number unit 150 of the security protocol device 100. The identification number unit 440 may also generate identification numbers IN according to identification data ID of record data RD. The terminal device 400 may verify whether the security protocol device 100 acquires data from the correct leaf node LN by using the identification number unit 440. For example, if the terminal device 400 needs to verify a certain record datum RD, and identification data ID of the record data RD is “E1534391” (refer to the foregoing example), when the terminal device 400 transmits the verification request to the security protocol device 100, the location search unit 160 of the security protocol device 100 may locate a hash value RDH of the record datum RD by using an identification number IN corresponding to the record datum RD, find that it is located in the leaf node LN numbered 13 of the binary tree BT in the database device 200, and return the hash value RDH in the leaf node LN numbered 13 to the terminal device 400 for the terminal device 400 to perform verification. Similarly, the identification number unit 440 of the terminal device 400 may also generate an identification number IN according to the identification data ID “E1534391” of the record datum RD, and obtain that the hash value RDH of the record datum RD should be stored in the leaf node LN numbered 13 based on the identification number IN. Therefore, the terminal device 400 may confirm whether the hash value RDH of the record datum RD returned by the security protocol device 100 comes from the correct location (e.g., the leaf node LN numbered 13).

As shown in FIG. 5, in some implementations, the smart contract 310 of the blockchain device 300 may further include a chain processing unit 311 and an accumulative sequence number unit 312. The identification sequence number unit 180 of the security protocol device 100 may be configured to generate identification sequence numbers IS. The accumulative sequence number unit 312 of the blockchain device 300 may be configured to generate accumulative sequence numbers AS. The chain processing unit 311 may be configured to generate chain data strings CDS.

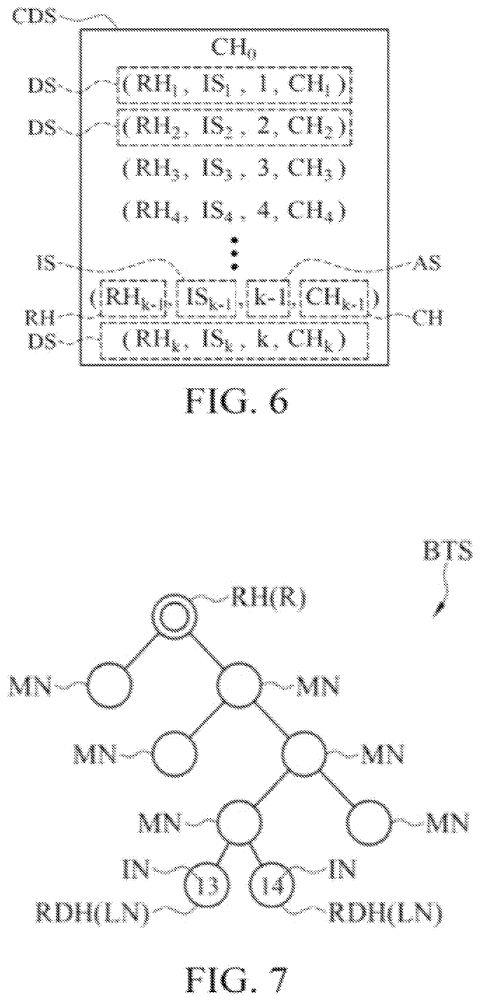

FIG. 6 is a schematic diagram illustrating a chain data string CDS, in accordance with an example implementation of the present disclosure.

Referring to FIGS. 5 and 6, in some implementations, each data set DS of the chain data string CDS may include a root hash RH, an identification sequence number IS, an accumulative sequence number AS, and a chain hash CH. The chain hash CH of each data set DS may be related to the root hash RH, the identification sequence number IS, the accumulative sequence number AS, and the chain hash CH of the previous data set DS. The chain hash CH of the first data set DS may be related to an initial chain hash CH₀.

In some implementations, each data set DS of the chain data string CDS may include a root hash RH, an identification sequence number IS, and a chain hash CH but not include an accumulative sequence number AS, and the chain hash CH of each data set DS may be related to the root hash RH, the identification sequence number IS, and the chain hash CH of the previous data set DS. The chain hash CH of each data set DS may be generated by hashing the previous data set DS, and the chain hash CH of the first data set DS may be generated by hashing the initial chain hash CH₀.

As shown in FIGS. 5 and 6, in some implementations, the identification sequence number IS of each data set DS of the chain data string CDS may respectively correspond to each root hash RH. When the security protocol device 100 transmits the root hashes RH to the blockchain device 300, the security protocol device 100 may further accordingly generate the identification sequence numbers IS and transmit the identification sequence numbers IS to the blockchain device 300.

For example, the identification sequence number IS may include a time stamp related to the corresponding root hash RH. When the security protocol device 100 generates a certain root hash RH at a specific time point, the identification sequence number unit 180 may generate an identification sequence number IS corresponding to the specific time point. The identification sequence number IS may include a time stamp corresponding to the specific time point. In other words, the root hashes RH generated at different time points may definitely correspond to different identification sequence numbers IS. As time elapses, a time point corresponding to a time stamp of an identification sequence number IS of a root hash RH generated later may be definitely later than a time point corresponding to a time stamp of an identification sequence number IS of a root hash RH generated earlier. Correspondingly, in the chain data string CDS, a time point corresponding to a time stamp of an identification sequence number IS of the latter data set DS may be definitely later than a time point corresponding to a time stamp of an identification sequence number IS of the former data sets DS. Therefore, the non-modifiability of the data sets DS of the chain data string CDS may be enhanced, so that the data of the chain data string CDS is difficult to be tampered with.

As shown in FIGS. 5 and 6, in some implementations, the accumulative sequence number AS of each data set DS of the chain data string CDS may respectively correspond to each root hash RH, and the accumulative sequence number AS of each data set DS may be an accumulative value of the accumulative sequence number of the previous data set DS. When the security protocol device 100 transmit the root hashes RH and the identification sequence numbers IS to the blockchain device 300, the accumulative sequence number unit 312 of the blockchain device 300 may sequentially generate the accumulative sequence numbers AS corresponding to the root hashes RH and the identification sequence numbers IS.

For example, when the blockchain device 300 receives the first root hash RH and the corresponding identification sequence number IS, the accumulative sequence number unit 312 may generate an accumulative sequence number AS having a value of integer 1, and the chain processing unit 311 may integrate the first data set DS, including the first root hash RH, the corresponding identification sequence number IS, the accumulative sequence number AS having a value of integer 1, and the corresponding chain hash CH. When the security protocol device 100 receives the second root hash RH and the corresponding identification sequence number IS, the accumulative sequence number unit 312 may accumulate 1 to the previous accumulative sequence number AS to generate an accumulative sequence number AS having a value of integer 2, and the chain processing unit 311 may integrate the second data set DS, including the second root hash RH, the corresponding identification sequence number IS, the accumulative sequence number AS having a value of integer 2, and the corresponding chain hash CH. In other words, the accumulative sequence number AS may be continuously accumulated, and the accumulative sequence number AS of the data set DS generated later may be definitely greater than the accumulative sequence number AS of the data set DS generated earlier. Moreover, the accumulative sequence number AS may be generated by the blockchain device 300 on the blockchain, and has non-repudiation. Therefore, the non-modifiability of the data sets DS of the chain data string CDS may be enhanced, so that the data of the chain data string CDS is difficult to be tampered with.

In some implementations, the chain processing unit 311 may generate multiple data sets DS chained in a series manner in the chain data string CDS according to the following two formulas:

CHᵢ=hash(RHᵢ₋₁|ISᵢ₋₁|CHᵢ₋₁); and

CH₁=hash(CH₀),
where RHᵢ₋₁ is root hash RH, ISᵢ₋₁ is identification sequence number IS, i−1 is accumulative sequence number AS, CHᵢ₋₁ is chain hash CH, and i is an integer from 2 to k.

As shown in FIG. 6, the first data set DS may have a root hash RH of RH₁, an identification sequence number IS of IS₁, an accumulative sequence number AS of 1, and a chain hash CH of CH₁, and CH₁ is a hash value generated by hashing CH₀. The latter (arranged after the first data set DS) second data set DS may have a root hash RH of RH₂, an identification sequence number IS of IS₂, an accumulative sequence number AS of 2, and a chain hash CH of CH₂, and CH₂ may be the hash value generated by hashing the connected RH₁, IS₁, 1 and CH₁. The latter (arranged after the second data set DS) third data set DS may have a root hash RH of RH₃, an identification sequence number IS of IS₃, an accumulative sequence number AS of 3, and a chain hash CH of CH₃, and CH₃ may be the hash value generated by hashing the connected RH₂, IS₂, 2 and CH₂. The last data set DS may have a root hash RH of RHₖ, an identification sequence number IS of ISₖ, an accumulative sequence number AS of k, and a chain hash CH of CHₖ, and CHₖ may be a hash value generated by hashing the connected RHₖ₋₁, ISₖ₋₁, k−1 and CHₖ₋₁. The root hashes RH, the identification sequence numbers IS, the accumulative sequence numbers AS, and the chain hashes CH of the rest data sets DS may be deduced by analogy. Moreover, these data sets DS chained in a series manner may form the chain data string CDS.

As shown in FIGS. 5 and 6, in some implementations, the security protocol device 100 may store the binary tree BT and the initial chain hash CH₀ in the database device 200, and the security protocol device 100 may also store the identification sequence numbers IS and the accumulative sequence numbers AS of the root hashes RH corresponding to the binary trees BT (or the data sets DS corresponding to the chain data string CDS) in the database device 200. When the security protocol device 100 receives the read request RR, the read request RR is to read multiple root hashes RH, and the plurality of root hashes RH belongs to multiple data sets DS of a certain chain data string CDS, the read unit 130 may read the root hash RH of the latter data set DS of the chain data string CDS from the blockchain device 300, and read one or more of the root hashes RH of the former data sets DS of the chain data string CDS from the database device 200, and the security protocol device 100 may verify the correctness of the former one or more root hashes RH of the database device 200 by using the chain hash CH of the latter data set DS of the blockchain device 300.

For example, when the security protocol device 100 receives the read request RR, and the read request RR is to read k root hashes RH from RH₁ to RHₖ of the chain data string CDS as in FIG. 6, the read unit 130 may read the root hash RH and the chain hash CH (e.g., RHₖ and CHₖ) of the last data set DS of the data sets DS of the chain data string CDS from the blockchain device 300, and the read unit 130 may read the root hashes RH (from RH₁ to RHₖ₋₁), the identification sequence numbers IS (from IS₁ to ISₖ₋₁), and the accumulative sequence numbers AS (from 1 to k−1) of the former data sets from the database device 200. The verification unit 120 may verify the correctness of RH₁ to RHₖ₋₁ of the former data sets DS of the database device 200 by using RHₖ of the last data set DS. The verification unit 120 may use the aforementioned two formulas and the initial chain hash CH₀, RH₁ to RHₖ₋₁, IS to ISₖ₋₁, and 1 to k−1 stored in the database device 200 to perform hashing and chaining operation to calculate CHₖ, and may compare the calculated CHₖ with CHₖ on the blockchain device 300. If the calculated CHₖ is consistent with CHₖ on the blockchain device 300, it may represent that RH₁ to RHₖ₋₁ stored in the database device 200 are consistent with RH₁ to RHₖ₋₁ on the blockchain device 300. Because it is based on hashing operation, as long as any root hash RH in RH₁ to RHₖ₋₁ stored in the database device 200 is inconsistent with the corresponding root hash RH in RH₁ to RHₖ₋₁ on the blockchain device 300, the calculated CHₖ may be different from CHₖ on the blockchain device 300.

In some implementations, the components in the verification systems 10, 10a and 10b may be arbitrarily combined. For example, the verification system 10b may not include the terminal device 400; or the verification systems 10 and 10a may include the terminal device 400 similar to the verification system 10b, but are not limited thereto.

FIG. 7 is a schematic diagram illustrating a slice BTS of a binary tree BT, in accordance with an example implementation of the present disclosure.

Referring to FIGS. 5 and 7, in some implementations, when the security protocol device 100 transmits the root hash RH of the binary tree BT to the blockchain device 300, the slicing unit 170 of the security protocol device 100 may cut the binary tree BT into multiple slices BTS and return the slices BTS to the corresponding terminal devices 400, and the slice verification unit 430 of each terminal device 400 may verify the correctness of each slice BTS received.

As shown in FIGS. 2 and 7, in some implementations, each slice BTS may be Merkle proof formed by a root R, two corresponding leaf nodes LN, and necessary middle nodes MN of the binary tree BT. The hash values RDH of the record data RD stored in the set of leaf nodes LN may be obtained through the foregoing operation process to obtain the root hash RH located at the root R. A root hash RH of the slice BTS should be consistent with the root hash RH of the complete binary tree BT. For example, after a certain terminal device 400 transmits a certain record datum RD and identification data ID to the security protocol device 100, the security protocol device 100 may store a hash value RDH of the record datum RD in a certain leaf node LN of a certain binary tree BT and return a slice BTS corresponding to the leaf node LN to the terminal device 400. The terminal device 400 may compare whether the hash value RDH of the record datum RD in the leaf node LN of the slice BTS is consistent with the original hash values RDH of the original record data RD generated by the terminal device 400. If they are consistent, it may indicate that the verification is correct. If they are inconsistent, it may indicate that the verification is incorrect. If the verification is incorrect, the corresponding terminal device 400 may transmit a protest message to the blockchain device 300 for subsequent data correction or invalidation or other procedures.

In some implementations, each terminal device 400 may include a blockchain chip. The blockchain chip may be, for example but not limited to, an integrated circuit (IC) that may transmit signals between the blockchain BC and the verification systems 10 and 10b. With the blockchain chip, the terminal device 400 may be designed to be lighter, thinner, and shorter, and the terminal device 400 may be more easily placed on any object or integrated into any electronic device.

For example, the terminal device 400 may be set or integrated into a battery (such as a large battery pack for electric or hybrid buses or automobiles), an electric meter, an automobile headlight, an automobile body (such as a driving computer of an automobile networked through 5G), or a frame. The terminal device 400 may automatically and continuously upload the record data RD of each object. The record data RD may be, for example but not limited to, hourly or daily (depending on the scheduled upload interval) historical use of the battery, the electric meter or the automobile headlight, or hourly or daily historical sensing data of sensor information (such as the engine, the odometer, the number of starts, etc.) of the automobile body, or the historical sensing data of the hourly or daily temperature and humidity changes sensed by the sensor on the frame, and the original data of the painter, etc. The security protocol device 100 may store the hash values RDH of the record data RD to the database device 200 via the off-chain framework OC, and upload the root hash RH to the blockchain device 300.

Based on the verification systems 10, 10a and 10b, in addition to rapid locating and searching of various data by the database device 200 via the off-chain framework OC, the non-repudiation of the data may also be achieved by verification of the blockchain BC. Moreover, based on the collocation application of the terminal device 400, the situation of the object may be guaranteed, and the value of the object may be improved. For example, used large battery packs used in long-haul vehicles may be transferred to short-haul vehicles after use to a certain degree, while the used large battery packs used in short-haul vehicles may be transferred to places, such as fishing farms, as backup power generation batteries after use to a certain degree. Each conversion may be performed through a platform, such as a trading platform for used objects. The situation of the object may be verified by the verification systems 10, 10a, and 10b in each transaction, thereby improving the reliability of the object quality and the value of the object.

In some implementations, the slice BTS may be stored in the database device 200 with the record data RD, and the root hash RH of the slice BTS may be stored in the blockchain device 300. As such, the record data RD may be verified efficiently. In other words, the slice BTS may be considered as a proof of the record data RD stored in the database device 200.

For example, in a case that a terminal device 400 downloads the record data RD and the corresponding slice BTS from the database device 200, the terminal device 400 may obtain the root hash RH from the blockchain device 300 and verify the downloaded record data RD using the downloaded slice BTS and the root hash received from the blockchain device 300 based on the characteristics of the blockchain BC. For example, the terminal device 400 may calculate a hash value RDH of the downloaded record data RD, calculate a root hash RH of the downloaded slice BTS using the calculated hash value RDH, and compare the calculated root hash RH with the root hash RH obtained from the blockchain device 300. In a case that the calculated root hash RH is consistent with the root hash RH obtained from the blockchain device 300, it may indicate that the verification is correct or that the downloaded record data RD is intact; and in a case that the calculated root hash RH is inconsistent with the root hash RH obtained from the blockchain device 300, it may indicate that the verification is incorrect or that the downloaded record data RD is compromised.

In some implementations, the size of one slice BTS may be, for example, approximately 3 KB.

In some implementations, based on the nature of the records, a record may sometimes change over time. For example, records may include car warranty/maintenance/repair records or output of an employee's work, where the content of such records may change over time. Although the aforementioned methods may verify the accuracy of one piece of data (e.g., the most recently recorded data), each modification made to the whole record may not be trackable. Therefore, the following implementations of the present disclosure propose a solution for these issues.

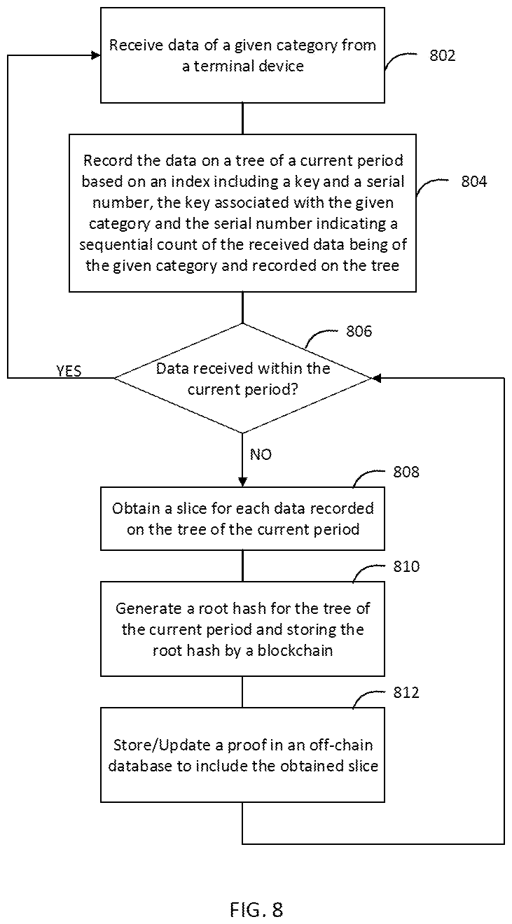

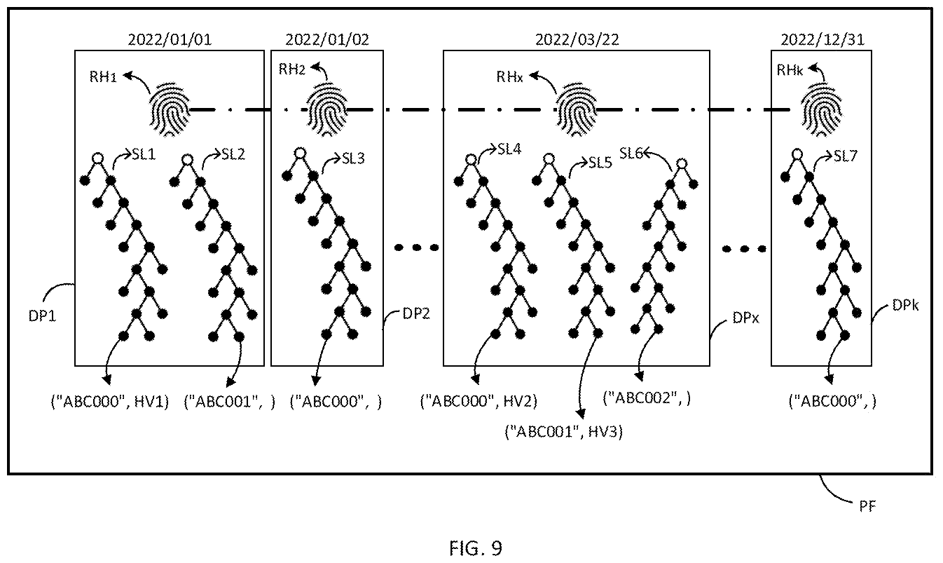

FIG. 8 is a flowchart illustrating a method for blockchain-based data management, in accordance with an example implementation of the present disclosure. The method may be performed by a device, such as a security protocol device. FIG. 9 is a schematic diagram illustrating a proof, in accordance with an example implementation of the present disclosure.

A new proof structure is introduced by example implementations illustrated in FIGS. 8 and 9. Based on the new proof structure, each update or new data entry within a category may be precisely recorded and tracked, resulting in maintaining immutability and integrity of data, and ensuring traceability and transparency of data changes.

It should be noted that the term “category” in the present implementations may be used to define a specific classification for organizing data. Each “category” may represent a distinct group or type of data or digital files, such as a dynamic Non-Fungible Token (NFT), digital asset, or a collection of records such as maintenance logs of a vehicle, or output of a person's (e.g., an employee's) work-Within each category, data entries may be dynamic, allowing for updates and changes over time. For example, in a “dynamic NFT” category, content may evolve, such as updates to the metadata or changes in the linked digital assets. Similarly, in the category of “maintenance records of a vehicle,” new maintenance entries may be added over time, reflecting ongoing vehicle upkeep.

It should be also noted that the following implementations are described in conjunction with the aforementioned system. However, those skilled in the art should be able to modify the necessary hardware/software configurations based on their requirements, drawing upon the following descriptions. The implementations are described and provided for illustrative purposes and are not intended to limit the scope of the invention. They demonstrate the flexibility and versatility of the system, underscoring its applicability across various hardware and software environments.

Referring to FIG. 8, in action 802, a (security protocol) device 100 may receive data of a category from a terminal device 400. In action 804, the security protocol device 100 may record the data on a tree based on an index.

Specifically, a tree used for recording the data may be established in a predetermined period, and the received data may be recorded on a tree. Specifically, the received data may be recorded on the tree based on an index. The index may be used for identifying or searching a leaf node, such as the use of the identification data ID, as described above (e.g., with reference to FIG. 2). More specifically, the index may include two parts: a key and a serial number.

In some implementations, the tree may be, for example but not limited to, a binary tree, such as a Merkle tree, and the recording may adopt the method described with reference to FIG. 2. According to the method described with reference to FIG. 2, a position in a Merkle tree is determined based on a hash value of the index value. Therefore, the tree may also be referred to as a transaction positioned Merkle tree (tp-Merkle tree) in the present disclosure.

In some implementations, a predetermined period may be, for example, but not limited to, one day.

In some implementations, the key of the index is associated with the corresponding category. Therefore, data of the same category may be recorded based on an index having the same key. For example, the key may be, or may be corresponding to, a smart contract identifier, a vehicle identification number (VIN), a public key or a wallet address of a person (e.g., data depositor), an employee ID number, etc. For example, a smart contract identifier may be a hash value of the key.

In some implementations, the serial number of the index may indicate a sequential count of the data (which is of the category (e.g., corresponding to the key) and recorded on the tree) within the current period (e.g., a day). The indication may be based on a predetermined rule designed for generating the serial number. For example, the predetermined rule may dictate that the serial number starts from zero and may be incremented by one with each subsequent data belonging to the same category and recorded on the tree. This means that the initial data within a given category recorded on the tree may be assigned a serial number of “0”. Thereafter, every new coming data in the same category recorded on the same tree may follow a sequential numbering pattern, with each recorded data receiving a serial number that is greater than the previous recorded data by one. It should be noted that, in the implementations of the present disclosure, the serial number is exemplified with three bits. However, the present disclosure does not limit the number of bits in the serial number, and those skilled in the art may implement the number of bits as needed, according to the requirements.

For example, for a first category corresponding to a first key “ABC”, a serial number of the initial data (e.g., first data) of the first category received within the current period may be “000”, and, as such, an index for recording the first data on a tree (e.g., the first tree) corresponding to the current period may be “ABC000;” a serial number of the next data (e.g., second data) of the first category received within the current period may be “001”, and, as such, an index for recording the second data on the first tree may be “ABC001.”

For example, for a second category corresponding to a second key “DEF”, a serial number of the initial data (e.g., third data) of the second category received within the current period may be “000”, and, as such, an index for recording the third data one the first tree may be “DEF000;” in a case that a next data of the second category is received, a serial number of the next data (e.g., fourth data) of the second category received within the current period may be “001”, and, as such, an index for recording the fourth data on the first tree may be “DEF001.”

Referring to FIG. 8, in action 806, within the current period, the security protocol device 100 may continue to monitor data, and when data is received, record it on the tree by repeating actions 802 and 804. It should be noted that the terminal device 400, from which the data is received during the repetitive action 802, may be the same device that the previous data is received from or may be a different device (e.g., a different terminal device).

In action 808, the security protocol device 100 may obtain a slice for each data recorded on the tree. Specifically, the obtained slice(s) may be partitioned from the tree and associated with the index corresponding to each data. The slice(s) may be obtained based on the method described in implementations of FIG. 7, in which case the details are not repeated herein. It should be noted that each slice obtained may include or may correspond to a timestamp or a tree ID, such that the period (or the tree) may be indicated thereby.

In some implementations, the security protocol device 100 may return the slice(s) to the corresponding terminal device 400 from which the data corresponding to the slice is received. For example, when a first data of a first category is received from a terminal device 400, the security protocol device 100 may return a first slice corresponding to the first data to the terminal device 400. Similarly, when a second data of the first category is received from another terminal device 400, the security protocol device 100 may return a second slice corresponding to the second data to the other terminal device 400.

In action 810, the security protocol device 100 may generate a root hash for the tree and store the root hash by a blockchain BC.

In some implementations, based on the received root hash, the blockchain BC may establish a chain data string CDS using the method described in FIGS. 3, 3a, and 6. For example, a root hash may be received by the blockchain each period (e.g., a day), and a data set DS may be generated for the chain data string CDS each period. The data set DS corresponding to the currently received root hash may include the currently received root hash and a chain hash CH which is associated with a previously-received root hash (e.g., which is included in a previous data set DS) that has been received by the blockchain BC before. As described in FIGS. 3, 3a, and 6, the chain data string CDS may be generated based on an initial value, such as the initial chain hash CH₀.

In some implementations, the data set DS may include at least one of the identification sequence number IS and the accumulative sequence number AS.

In some implementations, the execution order of action 806 and action 810 may be interchanged.

In action 812, the security protocol device 100 may store/update a proof in the database device 200 to include the slice(s) obtained in action 808.

For example, first data and second data may be of a first category and recorded on a first tree. The security protocol device 100 may store/update a first proof (e.g., corresponding to the first category) in the databased device 200. The stored/updated first proof may include a first slice partitioned from the first tree and associated with a first index (e.g., “ABC000”) for recording the first data, and a second slice partitioned from the first tree and associated with a second index (e.g., “ABC001”) for recording the second data.

In some implementations, each time the security protocol device 100 stores/updates the proof in the database device 200, for each category, the proof may include a supplementary slice partitioned from the tree and including a leaf node with a supplementary index calculated based on the predetermined rule. In addition, the leaf node may record no content. Specifically, for a given category, the supplementary slice may be partitioned from the tree and include a leaf node having a supplementary index with the key corresponding to the given category and with a supplementary serial number. The supplementary serial number may indicate a total count of data that are of the given category and recorded on the tree during the current period. For example, the supplementary serial number may be a next serial number for the given category in the current period.

For example, first data and second data may be of a first category and recorded on a first tree within a particular period. The security protocol device 100 may store a first proof corresponding to the first category, and the first proof may include a first slice partitioned from the first tree and associated with a first index (e.g., “ABC000”) for recording the first data, and a second slice partitioned from the first tree and associated with a second index (e.g., “ABC001”) for recording the second data. The first proof may include a supplementary slice partitioned from the first tree and the supplementary slice may include a leaf node. The leaf node may be corresponding to a third index (e.g., “ABC0002”) with the first key (e.g., “ABC”) and a next serial number for the first category. In addition, the leaf node may record no content. According to the supplementary slice with the leaf node recording no content, the total count of data of the first category (e.g., based on the key “ABC”) and recorded on the first tree (e.g., based on the timestamp or the tree ID of the supplementary slice) may be determined (e.g., as being two).

For example, no data may be of a second category and recorded on the first tree within a certain period. The security protocol device 100 may store a second proof (e.g., the same as or different from the first proof) corresponding to the second category, and the second proof may include the supplementary slice only. The supplementary slice may be partitioned from the first tree and may include a leaf node. The leaf node may correspond to a fourth index (e.g., “DEF000”) with the second key (e.g., “DEF”) and a next serial number (e.g., the initial serial number “0”) for the second category. In addition, the leaf node may record no content. According to the supplementary slice with the leaf node recording no content, the total count of data of the second category (e.g., based on the key “DEF”) and recorded on the first tree (e.g., based on the timestamp or the tree ID of the supplementary slice) may be determined (e.g., as being zero).

After action 812, a next period may be started from action 806. For example, in a case that data is received from a terminal device 400 within the next period, actions 802 to 812 may be repeated for the next period; in a case that no data is received within the next period, actions 808 to 812 may be performed and, as such, in action 812 the security protocol device 100 may update the proof corresponding to each category by including the supplementary slice only.

In some implementations, the process may end after the process is performed for a (predetermined) number of periods. In some implementations, the process may not end until intentionally halted. For instance, an administrator of the device 100 may stop the process for a specific category, e.g., according to a user's instruction.

Referring to FIG. 9, a one-year history-traceable proof PF is illustrated. The proof PF may be stored/updated in the database device 200 every day according to the method described in FIG. 8. As such, the proof PF may include multiple daily proofs DP1, DP2, . . . DPx, . . . , DPk, for example, according to the timestamps or the tree IDs of the slices in the proof PF. The size of the one-year proof PF may be, for example, approximately 1.5 MB.

It should be noted that only slices corresponding to a first category (e.g., a corresponding key may be “ABC”) is illustrated in FIG. 9. However, the present disclosure is not limited thereto. The proof PF may also include slices corresponding to other categories or keys.

As shown in FIG. 9, the daily proof DP1 may be stored/updated for a certain date (e.g., Jan. 1, 2022, or 2022 Jan. 1), and may include two slices SL1 and SL2. The slice SL1 may be partitioned from the tree established on the same date (e.g., 2022 Jan. 1) and associated with an index “ABC000”. The content of the leaf node of index “ABC000” may include a hash value HV1 of the first data of the first category recorded on the tree established on 2022 Jan. 1. The slice SL2 may be the supplementary slice having a leaf node of index “ABC001” and the leaf node of index “ABC001” may record no content. It should be noted that the root hashes of all slices in the daily proof DP1 may be the same since they are all partitioned from the same tree. According to the leaf node associated with the index “ABC001” and recording no content, it may be determined that only one piece of data of the first category is received and recorded on 2022 Jan. 1. According to the daily proof DP1, the hash value of the one piece of data of the first category is HV1.

As shown in FIG. 9, the daily proof DP2 may be stored/updated for 2022 Jan. 2, and may include only one slice SL3. The slice SL3 may be the supplementary slice having a leaf node of index “ABC000” and the leaf node of index “ABC000” may record no content. According to the leaf node associated with the index “ABC000” and recording no content, it may be determined that no data of the first category is received and recorded on 2022 Jan. 2.

As shown in FIG. 9, the daily proof DPx may be stored/updated for 2022 Mar. 22, and may include three slices SL4, SL5, and SL6. The slice SL4 may be partitioned from the tree established on 2022 Mar. 22 and associated with an index “ABC000”. The content of the leaf node of index “ABC000” may include a hash value HV2 of the first data of the first category recorded on the tree established on 2022 Mar. 22. The slice SL5 may be partitioned from the tree established on 2022 Mar. 22 and associated with an index “ABC001”. The content of the leaf node of index “ABC001” may include a hash value HV3 of the second data of the first category recorded on the tree established on 2022 Mar. 22. The slice SL6 may be the supplementary slice having a leaf node of index “ABC002” and the leaf node of index “ABC0002” may record no content. According to the leaf node associated with the index “ABC0002” and recording no content, it may be determined that two pieces of data of the first category is received and recorded on 2022 Mar. 22. According to the daily proof DP3, the hash values of the two pieces of data of the first category are HV2 and HV3 in a recorded order.

As shown in FIG. 9, the daily proof DPk may be stored/updated for 2022 Dec. 31, and may include only one slice SL7. The slice SL7 may be the supplementary slice having a leaf node of index “ABC000” and the leaf node of index “ABC000” may record no content. According to the leaf node associated with the index “ABC000” and recording no content, it may be determined that no data of the first category is received and recorded on 2022 Dec. 31.

It should be noted that the root hash of all slice(s) in one daily proof may be the same since they are all partitioned from the same tree. In addition, the root hash of each daily proof of the proof PF may be chained together, e.g., based on the method described in FIGS. 3, 3a, and 6. As shown in FIG. 9, multiple root hashes RH₁ to RHₖ of the daily proof DP1 to DPk may be chained together. In some implementations, the root hashes RH₁ to RHₖ may be included in the proof PF and each root hash may be recorded as being associated with one tree (e.g., based on timestamps or tree IDs).

In some implementations, referring to FIGS. 3 and 9 simultaneously, a chain data string CDS corresponding to the proof PF may be established based on the root hashes RH₁ to RHₖ and an initial value CH₀ (which may also be referred to as an initial chain hash).

Specifically, the first data set DS may include the root hash RH₁ corresponding to 2022 Jan. 1 and the chain hash CH₁, and the chain hash CH₁ may be a hash value generated by hashing the initial value CH₀. The latter (arranged after the first data set DS) second data set DS may include the root hash RH₂ corresponding to 2022 Jan. 2 and the chain hash CH₂, and the chain hash CH₂ may be a hash value generated by hashing the connected root hash RH₁ and chain hash CH₁. As described above, hashing of the connected root hash RH₁ and chain hash CH₁ may be implemented by connecting root hash RH₁ and chain hash CH₁ and then performing the hashing, but is not limited thereto. The latter (arranged after the second data set DS) third data set DS may include the root hash RH₃ corresponding to 2022 Jan. 3 and the chain hash CH₃, and the chain hash CH₃ may be a hash value generated by hashing the connected root hash RH₂ and chain hash CH₂. The last data set DS may have the root hash RHₖ corresponding to 2022 Dec. 31 and the chain hash CHₖ, and the chain hash CHₖ may be a hash value generated by hashing the connected root hash RHₖ₋₁ (e.g., corresponding to 2022 Dec. 30) and chain hash CHₖ₋₁. The root hashes RH and the chain hashes CH of the rest data sets DS may be deduced by analogy. As such, these data sets DS chained in the series manner may form the chain data string CDS.

In some implementations, the security protocol device 100 may store the initial chain hash CH₀ in the database device 200, but is not limited thereto.

In some implementations, the blockchain BC may store (e.g., by a smart contract) the initial chain has CH₀, but is not limited thereto. In some implementations, the blockchain BC may receive the root hashes RH₁ to RHₖ, hence it may establish the chain data string CDS that includes the data set DS corresponding to each of the root hashes RH₁ to RHₖ (e.g., or to each day.)

According to the above, in a case that data of the first category and the proof PF are downloaded (e.g., from the database device 200), all the downloaded data may be efficiently verified and only a last root hash and chain hash (e.g., RHₖ and CHₖ) may need to be downloaded from the blockchain BC for verification. Details of such verification are already described with reference to FIGS. 3, 3a, and 6, and thus which are not repeated herein.

It should be noted that the verification may be performed by any off-chain devices/systems, such as the terminal device 400, the security protocol device 100, and/or a third-party verification server.

Various ways for verification are exemplified below for different requirements.

For example, referring to FIG. 9, in a case that the slice SL5 is removed from the database device 200, it may be rectified based on the indexes of the left slices SL4 and SL6 in the daily proof DP3. Specifically, this error may be discovered through the index with the key “ABC” skipping from “ABC000” to “ABC0002”, missing the intermediate “ABC001.” Therefore, the integrity of the slices within a downloaded proof PF may be verified.

For example, when a terminal device 400 downloads data of the first category and the corresponding proof PF from the databased device 200, the proof PF may be first verified by calculating the root hashes based on every slice in the proof PF. In a case that the root hashes of two slices in one daily proof are different, it may indicate that the proof PF is compromised.

For example, the proof may be further verified by calculating the root hashes based on every slice in the proof PF, and comparing the calculated root hashes with the root hashes RH₁ to RHₖ in the proof PF. In a case that the calculated root hashes are consistent with the root hashes RH₁ to RHₖ in the proof PF, it may indicate that the proof PF is intact; in a case that the calculated fingerprints are inconsistent with the root hashes RH₁ to RHₖ in the proof PF, it may indicate that the proof PF is compromised. Therefore, the downloaded proof PF may be verified.

For example, when a terminal device 400 downloads data of the first category and the corresponding proof PF from the databased device 200, each piece of downloaded data may be checked first by calculating hash value and comparing the calculated hash value with the corresponding leaf node of the corresponding slice. Therefore, the downloaded data may be verified.

For example, when a terminal device 400 downloads data of the first category and the corresponding proof PF from the databased device 200, all the verifications of the data and its entirely history of changes may be done by using the last root hash and chain hash (e.g., RHₖ and CHₖ) from the blockchain BC. Specifically, a device may obtain a last root hash and a last chain hash based on the proof PF (e.g., using the method described in FIGS. 3, 3a, and 6), and compare the obtained last root hash and the last chain hash with the last root hash and chain hash (e.g., RHₖ and CHₖ) from the blockchain BC. In a case that the obtained last root hash and the last chain hash are consistent with the last root hash and chain hash (e.g., RHₖ and CHₖ) obtained from the blockchain BC, the downloaded proof PF may be intact; in a case that at least one of the obtained last root hash and the last chain hash is inconsistent with the last root hash and chain hash (e.g., RHₖ and CHₖ) obtained from the blockchain BC, the downloaded proof PF may be compromised. In addition, each piece of downloaded data may be verified by calculating hash value and comparing the calculated hash value with the corresponding leaf node of the corresponding slice in the proof PF. Therefore, all downloaded data and the corresponding proof PF may be verified.

Accordingly, data of the category including each and every change may be recorded, retained and verified. At most, downloading the last root hash and chain hash (e.g., RHₖ and CHₖ) from the blockchain BC is sufficient to complete all the verifications of the data and its entire history of changes.

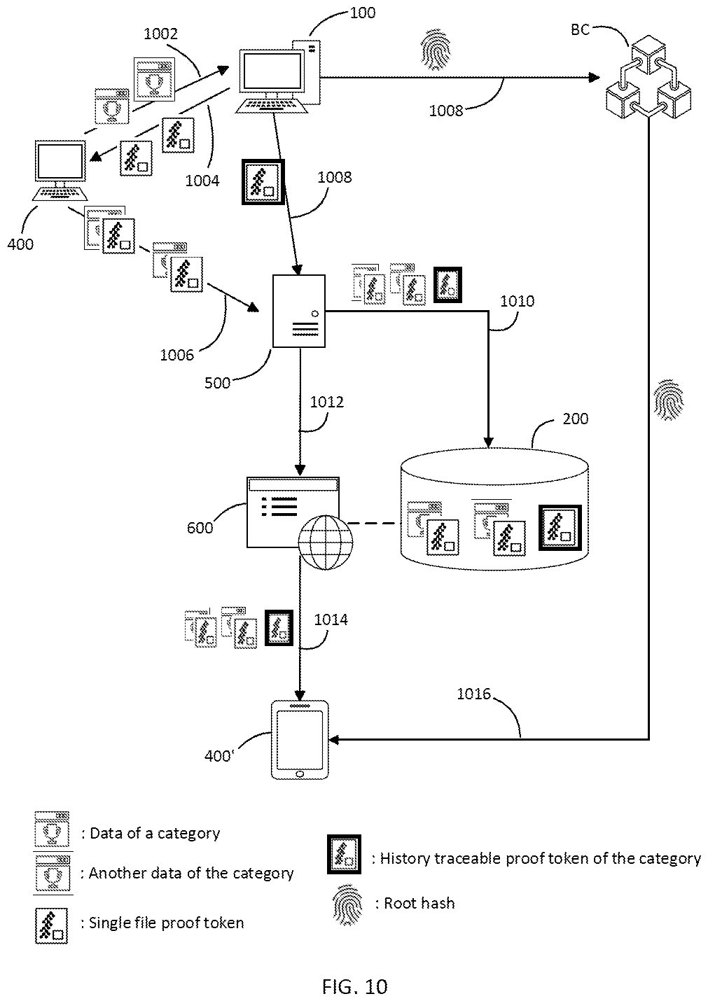

FIG. 10 is a schematic diagram illustrating a method for blockchain-based data management, in accordance with an example implementation of the present disclosure. Implementations described with respect to FIG. 10 may adopt the method described above.

Referring to FIG. 10, in action 1002, the terminal device 400 may transmit data of a category to the security protocol device 100. For example, the terminal device 400 may sequentially transmit at least one data of the category to the security protocol device 100 in action 1002.

In some implementations, the data may include an original digital file of the category. Specifically, the “original digital file” may refer to the initial, unaltered version of a file created and saved in a digital format. The original digital file may be the primary document or image, as directly produced by its creator, without any subsequent modifications, compressions, or conversions. The original digital file may represent the authentic and complete work in the most pristine digital form, preserving all its original characteristics, data, and quality, as intended by the author or artist. In contexts ranging from digital art, such as NFTs, to everyday work products like documents or images, the term “original digital file” may underscore the file's originality and integrity in the digital realm.

For example, the data may include an original digital file belonging to an NFT, and the category may be the NFT. For example, the data may include an original document or an original image made by an employee, and the category may be work output of the employee.

In some implementations, the data may be calculated based on the original digital file. For example, the data may include a hash value of the original digital file. For example, the data may include a hash value of an original digital file belonging to an NFT. For example, the data may include a hash value of an original document or image made by an employee.

In action 1004, the security protocol device 100 may record the data on a tp-Merkle tree. At an end of a predetermined period (e.g., a day), the security protocol device 100 may extract a single file proof token for returning to the terminal device 400. The single file proof token may include a slice corresponding to the data (e.g., the slice SL1, SL4, or SL5 illustrated in FIG. 9). The single file proof token may also include, for example, at least one of a timestamp, an attestor's public key, a tree ID of the corresponding tp-Merkle tree, and/or a wallet address corresponding to the received data.

In action 1006, the terminal device 400 may submit the original digital file and the corresponding single file proof token to a management server 500.

For example, the management server 500 may be an NFT manager and mint server. For example, the management server 500 may be a document management server.

In action 1008, at the end of the predetermined period, the security protocol device 100 may also generate a history traceable proof token (e.g., proof PF illustrated in FIG. 9) for the category and transmit the generated history traceable proof token to the management server 500. In addition, a root hash RH (e.g., one of the root hash RH₁ to RHₖ illustrated in FIG. 9) is also generated and stored by the blockchain BC at this stage.

In action 1010, the management server 500 may store the original digital file, the corresponding single file proof token and the corresponding history traceable proof token to the database device 200, and associate the original digital file with the corresponding single file proof token and with the corresponding history traceable proof token.

In some implementations, regarding the history traceable proof token, the security protocol device 100 and the management server may merely update the history traceable proof token in the database device 200, instead of generating a new one.

In action 1012, the management server 500 may create an interface 600 for accessing data of the category.

For example, the interface 600 may be a webpage or an application programming interface (API), which may provide a preview of the original digital file, and at least one of the single file proof token and the history traceable proof token. For example, the interface 600 may be provided on a server which is independent from the management server 500.

In a case that the management server 500 is an NFT manager and mint server, it may mint the NFT (e.g., by using smart contract) and set the URL of the NFT to the interface 600 (e.g., a webpage) at this stage. The NFT may be, for example, transferred in a secondary market.

In some implementations, actions 1002 to 1012 may be repeated as the content of the category may be dynamically changed over time, where action 1012 may only involve updating the content of the interface 600 (e.g., webpage), instead of creating a new one.

In some implementations, at least one of the security protocol device 100, the database device 200, and the management server 500 may be integrated into a data management system.

Referring to FIG. 10, in action 1014, a terminal device 400′ may download (e.g., from the database device 200 through the interface 600) original digital files belonging to the category and the history traceable proof token corresponding to the category.

For example, the original digital files may include every update of the NFT. For example, the original digital files may include all work output of an employee. For example, the original digital files may include all the maintenance and repair records of a vehicle.

In action 1016, the terminal device 400′ may obtain the last root hash and the last chain hash from the blockchain BC. Based on the method described above, the terminal device 400′ may verify the downloaded original digital files based on the history traceable proof token and the downloaded root hash and chain hash from the blockchain BC. It should be noted that the blockchain BC may generate the last root hash and the last chain hash by using the method described above, and thus the details are not repeated herein.

In some implementations, the verification may be conducted collaboratively by the terminal device 400′ and a third-party server. However, for the sake of brevity, this disclosure does not elaborate on the various modes of collaboration. Those skilled in the art may implement these as required based on their knowledge and understanding of the field.

In summary, the provided method for blockchain-based data management in the implementations of the present disclosure ensures data's immutability and integrity efficiently within a decentralized framework. The ability to handle dynamic content within categories, while maintaining the traceability and transparency of the changes, represents a significant advancement in efficient data management.

Based on the above descriptions, it is apparent that various techniques may be configured to implement the concepts described in this application without departing from their scope. Furthermore, although certain implementations have been specifically described and illustrated, those skilled in the art will recognize that variations and modifications may be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions may be made within the scope of the present disclosure.

What is claimed is:

1. A method for blockchain-based data management, the method comprising:
receiving first data of a first category;
recording the first data on a first tree based on a first index, the first index comprising a first key and a first serial number, the first key associated with the first category and the first serial number indicating a sequential count of the first data being of the first category and recorded on the first tree;
obtaining a first slice partitioned from the first tree and associated with the first index;
generating a first root hash of the first tree and storing the first root hash by a blockchain; and
storing a first proof in an off-chain database, wherein the first proof comprises the first slice partitioned from the first tree.

2. The method of claim 1, further comprising:
receiving second data of the first category after receiving the first data;
recording the second data on the first tree based on a second index, the second index comprising the first key and a second serial number determined based on the first serial number and a predetermined rule; and
obtaining a second slice partitioned from the first tree and associated with the second index, wherein the first proof further comprises the second slice of the first tree.

3. The method of claim 1, further comprising:
obtaining a supplementary slice partitioned from the first tree and associated with a supplementary index, the supplementary index comprising the first key and a supplementary serial number indicating a total count of data received that are of the first category and recorded on the first tree, wherein:
the first proof comprises the supplementary slice of the first tree, and
a leaf node of the first tree corresponding to the supplementary index records no content.

4. The method of claim 1, further comprising, after storing the first root hash by the blockchain:
obtaining a second slice partitioned from a second tree and associated with a second index, the second index comprising the first key and a second serial number determined based on a predetermined rule;
generating a second root hash of the second tree and storing the second root hash by the blockchain; and
updating the first proof corresponding to the first category in the off-chain database to include the second slice.

5. The method of claim 4, further comprising:
receiving second data of the first category;
recording the second data on the second tree based on the second index.

6. The method of claim 4, wherein a leaf node of the second tree corresponding to the second index records no content.

7. The method of claim 4, further comprising:
obtaining the first root hash of the first slice and the second root hash of the second slice from the off-chain database;
calculating a first chain hash based on the first root hash and the second root hash obtained from the off-chain database;
obtaining the second root hash and a second chain hash from the blockchain; and
verifying the first slice and the second slice in the off-chain database by comparing the first chain hash with the second chain hash.

8. The method of claim 7, wherein the second chain hash is calculated by the blockchain based on the first root hash.

9. The method of claim 1, wherein the first data is calculated according to an original digital file, the method further comprising:
receiving and storing the original digital file in the off-chain database; and
associating the original digital file with the first proof in the off-chain database.

10. The method of claim 1, further comprising:
receiving second data of a second category different from the first category;
recording the second data on the first tree based on a second index, the second index comprising a second key and a second serial number, the second key associated with the second category and different from the first key, and the second serial number indicating a sequential count of the second data being of the second category and recorded on the first tree; and
obtaining a second slice partitioned from the first tree and associated with the second index, wherein the first proof comprises the second slice partitioned from the first tree.

11. A system cooperating with a blockchain and an off-chain database, the system configured to:
receive first data of a first category;
record the first data on a first tree based on a first index, the first index comprising a first key and a first serial number, the first key associated with the first category and the first serial number indicating a sequential count of the first data being of the first category and recorded on the first tree;
obtain a first slice partitioned from the first tree and associated with the first index;
generate a first root hash of the first tree and store the first root hash by the blockchain; and
store a first proof in the off-chain database, wherein the first proof comprises the first slice partitioned from the first tree.

12. The system of claim 11, further configured to:
receive second data of the first category after receiving the first data;
record the second data on the first tree based on a second index, the second index comprising the first key and a second serial number determined based on the first serial number and a predetermined rule; and
obtain a second slice partitioned from the first tree and associated with the second index, wherein the first proof further comprises the second slice of the first tree.

13. The system of claim 11, further configured to:
obtain a supplementary slice partitioned from the first tree and associated with a supplementary index, the supplementary index comprising the first key and a supplementary serial number indicating a total count of data received that are of the first category and recorded on the first tree, wherein:
the first proof comprises the supplementary slice of the first tree, and
a leaf node of the first tree corresponding to the supplementary index records no content.

14. The system of claim 11, further configured to, after storing the first root hash by the blockchain:
obtain a second slice partitioned from a second tree and associated with a second index, the second index comprising the first key and a second serial number determined based on a predetermined rule;
generate a second root hash of the second tree and storing the second root hash by the blockchain; and
update the first proof corresponding to the first category in the off-chain database to include the second slice.

15. The system of claim 14, further configured to:
receive second data of the first category; and
record the second data on the second tree based on the second index.

16. The system of claim 14, wherein a leaf node of the second tree corresponding to the second index records no content.

17. The system of claim 14, further configured to:
obtain the first root hash of the first slice and the second root hash of the second slice from the off-chain database;
calculate a first chain hash based on the first root hash and the second root hash obtained from the off-chain database;
obtain the second root hash and a second chain hash from the blockchain; and
verify the first slice and the second slice in the off-chain database by comparing the first chain hash with the second chain hash.

18. The system of claim 17, wherein the second chain hash is calculated by the blockchain based on the first root hash.

19. The system of claim 11, wherein the first data is calculated according to an original digital file, the system further configured to:
receive and store the original digital file in the off-chain database; and
associate the original digital file with the first proof in the off-chain database.

20. The system of claim 11, further configured to:
receive second data of a second category different from the first category;
record the second data on the first tree based on a second index, the second index comprising a second key and a second serial number, the second key associated with the second category and different from the first key, and the second serial number indicating a sequential count of the second data being of the second category and recorded on the first tree; and
obtain a second slice partitioned from the first tree and associated with the second index, wherein the first proof comprises the second slice partitioned from the first tree.
